(19) United States
(12) Patent Application Publication
(10) Pub. No.: US 2009/0006147 A1
(43) Pub. Date: Jan. 1, 2009

(54) METHOD AND SYSTEM FOR DEFINING AND MANAGING INFORMATION TECHNOLOGY PROJECTS BASED ON CONCEPTUAL MODELS

(76) Inventor: Harirajan Padmanabhan, Overland Park, KS (US)

Correspondence Address: SCHMEISER, OLSEN & WATTS, 22 CENTURY HILL DRIVE, SUITE 302, LATHAM, NY, 12110, US

(21) Appl. No.: 11/768,946

(22) Filed: Jun. 27, 2007

(51) Int. Cl. G06Q 10/00

(52) U.S. Cl. 705/7

(57) ABSTRACT

A method and system for defining and managing an information technology project based on a conceptual model. Business requirements of an information technology (IT) solution that indicate a need for an update of a pre-defined conceptual model are defined. Sub-projects of an IT project are defined, which includes aligning the sub-projects with the pre-defined conceptual model's conceptual components that require design or implementation modifications and/or with subcomponents of the conceptual components. The pre-defined conceptual model is updated, a sub-project-based execution phase of the IT project is performed and the IT project is managed.

### FIELD OF THE INVENTION

The present invention relates to a method and system for defining and managing information technology projects based on conceptual models, and more particularly to a technique for defining and managing information technology projects based on modularized and business-aligned conceptual components of conceptual models.

### BACKGROUND OF THE INVENTION

Conventionally, information technology (IT) solutions are designed, built and tested using methods that make IT projects inflexible to changing business requirements. Current practices undermine collaboration between business and IT stakeholders throughout the IT solution development lifecycle. Current methods rely on business requirements being handed off to the IT domain for design and implementation. IT project definitions and plans are focused on designing and building the technical components and subsystems needed to meet the business requirements. Typically, the scope of enhancements and modifications made through an IT project covers only certain portions of an IT solution. Business requirements are often expressed as changes to specific applications that form part of an IT solution. Thus, IT projects completed at different times may change different portions of an IT solution or applications. Given that current methods used to define an IT project and develop project plans focus on designing and building technical components and subsystems needed to meet the business requirements that are within the scope of the project, it is very difficult to get a stable end-to-end view of the business capabilities within an IT solution, even for IT stakeholders, let alone business stakeholders. These current methods lead to the often-criticized silo or stove-pipe approach to building IT solutions. Further, in current methods, the IT project structure and activities are not meaningful to business stakeholders and therefore, business stakeholders generally do not concern themselves with the approach and details of the IT project that will deliver the IT solution to meet their business needs. Instead, the business stakeholders focus on the completion dates by which the IT projects will deliver the IT solution and the progress of the IT project activities toward meeting those dates. In addition to hindering collaboration between business and IT stakeholders, this situation indicates that the IT stakeholders focus on delivering technical components that meet the business requirements provided to them and have little opportunity to engage business stakeholders during the solution development stages. Still further, conventional modular units of an IT solution are based on technical structures rather than business-oriented structures. For example, the modular units may be services, Business Process Execution Language (BPEL) modules, Web Services Description Language (WSDL) documents, Enterprise JavaBeans (EJBs), servlets, applets, Java® classes, Dynamic Link Libraries (DLLs), EXEs, etc. Using modular structures such as these to plan and manage the work units of IT projects is suitable for the IT community, but they do not foster collaboration with business stakeholders. Further yet, conventional utilization of use case specifications to analyze and develop designs that can most optimally deliver the functionality in an IT solution do not naturally lead to a modular view of a system and therefore exhibit less flexibility and responsiveness from a business perspective. Given the aforementioned conventional practices, understanding the impact to IT projects when business requirements change during the course of an IT project requires extensive analysis by various IT stakeholders to fully uncover the dependencies on the different system development activities. Refactoring the technical designs and corresponding project plan activities is a tedious process that requires careful re-balancing of resources and priorities in order to complete the changes within the timelines demanded by the business domain. Moreover, current testing strategies delay the business validation of the IT solution functionality until a late testing stage (i.e., user acceptance testing, which follows unit testing, integration testing and system testing), thereby minimizing the impact of any collaboration between business and IT stakeholders on business capabilities realized. Thus, there exists a need to overcome at least one of the preceding deficiencies and limitations of the related art.

### SUMMARY OF THE INVENTION

The present invention provides a method of defining and managing an information technology project based on a conceptual model, comprising:

defining, by one or more business stakeholders utilizing a computing system, a plurality of business requirements of an information technology (IT) solution, wherein the plurality of business requirements indicate a need for an update of a pre-defined conceptual model that represents a design of the IT solution, the pre-defined conceptual model including a plurality of conceptual components, the plurality of conceptual components representing one or more hardware components of the IT solution, one or more software components of the IT solution or a combination of the one or more hardware components and the one or more software components;

defining, via the computing system, an IT project whose execution results in the IT solution, wherein the defining the IT project comprises defining a plurality of sub-projects of the IT project, wherein the defining the plurality of sub-projects comprises aligning the plurality of sub-projects with a subset of the plurality of conceptual components, a plurality of subcomponents of the subset, or any combination thereof, wherein the subset requires a plurality of modifications, each modification being a change in a design or an implementation of a conceptual component of the subset;

generating, via the computing system, the update of the pre-defined conceptual model;

performing, via the computing system, an execution phase of the IT project; and

managing, via the computing system, the IT project.

A system, computer program product, and a process for supporting computing infrastructure that provides at least one support service corresponding to the above-summarized method are also described and claimed herein.

Advantageously, the present invention provides technique for defining and managing information technology projects based on conceptual models. Further, the present invention enables breaking down information technology projects into smaller sub-projects that are based on conceptual components, thereby making the information technology projects more flexible and responsive to business needs. The breakdown by sub-project allows parts of an information technology solution to be designed and built independently, thereby allowing, for example, testing of the implementation of a conceptual component for business capabilities without requiring a full system integration. Still further, the present invention's usage of a conceptual model facilitates a more effective collaboration between business stakeholders and information technology stakeholders.

### BRIEF DESCRIPTION OF THE DRAWINGS

FIG. 1 is a block diagram of a system for defining and managing information technology projects based on conceptual model, in accordance with embodiments of the present invention.

FIG. 2 is a flow diagram of an information technology project definition and management process implemented by the system of FIG. 1, in accordance with embodiments of the present invention.

FIG. 3 is a flow diagram of a conceptual model-based information technology project definition process included in the process of FIG. 2, in accordance with embodiments of the present invention.

FIG. 4 is a flow diagram of a parallel execution of multiple sub-projects included in the process of FIG. 2, in accordance with embodiments of the present invention.

FIG. 5 is a flow diagram of an information technology project management process included in the process of FIG. 2, in accordance with embodiments of the present invention.

FIG. 6 is an exemplary conceptual structure for illustrating the processes of FIGS. 3-5, in accordance with embodiments of the present invention.

FIG. 7 is a block diagram of a computing system that implements the process of FIG. 2, in accordance with embodiments of the present invention.

### DETAILED DESCRIPTION OF THE INVENTION

### 1. OVERVIEW

The present invention provides a modular and flexible method and system for defining and managing information technology (IT) projects, where the approach includes breaking down IT projects into sub-projects based on business-aligned conceptual components of a conceptual model. The approach disclosed herein provides a common reference for business stakeholders and IT stakeholders through all stages of IT solution lifecycle processes, thereby enabling IT projects to become more flexible and more responsive to business needs. Any conceptual model described herein is developed using the method disclosed in U.S. patent application Ser. No. 11/751,951 entitled “Method and system for developing a conceptual model to facilitate generating a business-aligned information technology solution,” which is hereby incorporated by reference herein, in its entirety. The present invention may be incorporated into a project management method (e.g., the Worldwide Project Management Method offered by International Business Machines Corporation of Armonk, N.Y.).

### 2. DEFINITIONS

The below-listed terms are used herein and are defined as follows:

Information technology solution or IT solution: A collection of IT systems that support activities of a business, where each IT system in the collection is implemented by one or more hardware components and/or one or more software components.

Information technology project or IT project: The process that encompasses a set of tasks for building or updating an IT solution.

Information technology sub-project (a.k.a. sub-project): A distinct set of one or more tasks that are directed to a well-defined objective of an IT solution and that are included within an IT project comprising a larger set of tasks.

Conceptual model: A high-level abstraction of the design of an IT solution. A conceptual model provides a stable reference for IT solution development and includes a conceptual structure and a description (i.e., documentation) of operational concepts. A conceptual model is owned and understood by both business stakeholders and IT stakeholders.

Conceptual structure: A representation of the basic building blocks of an IT solution. The building blocks represented by the conceptual structure are conceptual components.

Conceptual component: A technology agnostic, modular representation that is one of the building blocks represented by a conceptual structure. A conceptual component is represented as an icon or a form, shape or figure determined by outlines (e.g., a closed plane figure or curve such as a rectangle or circle). When an IT solution is implemented, conceptual components are manifested as software components, hardware components or a combination thereof.

Operational concepts: Descriptions, using a conceptual structure as a basis, of how each conceptual component interacts with one or more other conceptual components to support and perform business functions that an IT solution is meant to support.

Business stakeholders: Non-technical personnel who have an interest in the outcome of an IT solution.

IT stakeholders: Technical personnel who have an interest in the outcome of an IT solution.

### 3. SYSTEM FOR DEFINING AND MANAGING IT PROJECTS

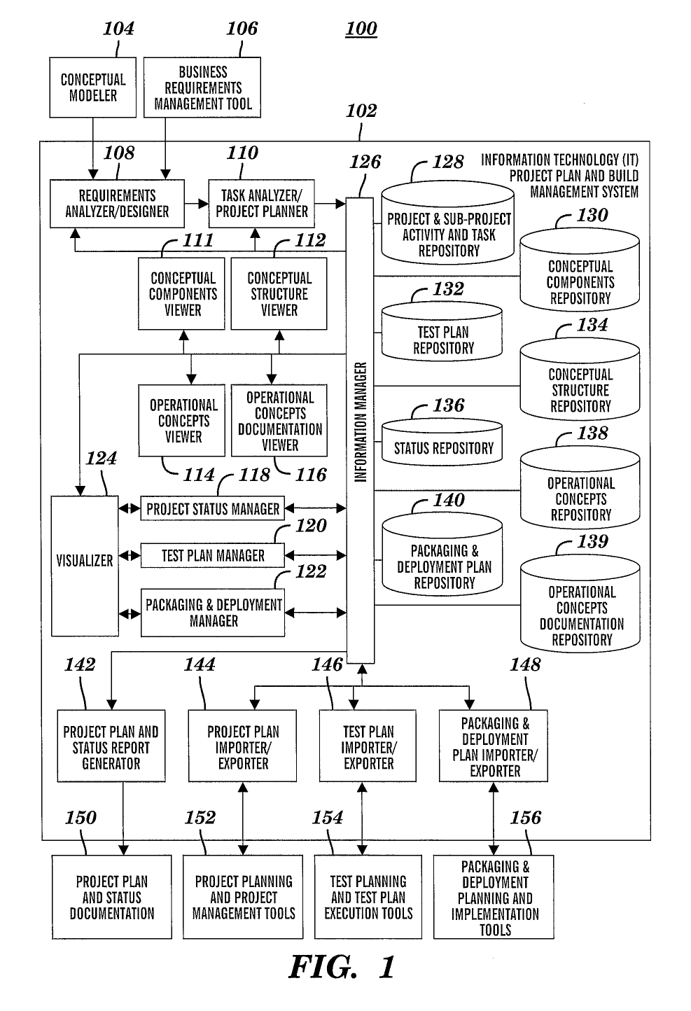

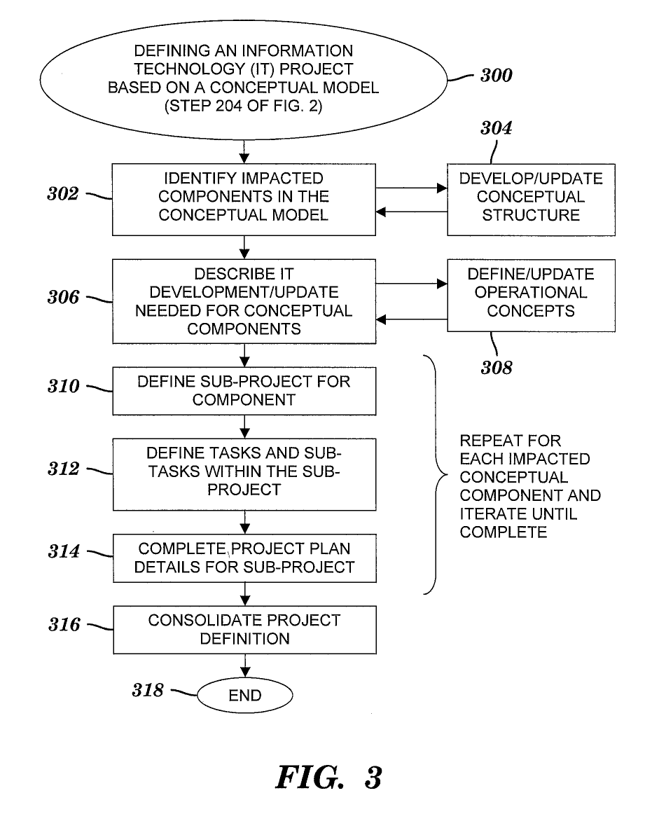

FIG. 1 is a block diagram of a system for defining and managing information technology projects based on conceptual model, in accordance with embodiments of the present invention. System 100 includes an IT project plan and build management system 102 that manages the planning and building of an IT project, a conceptual modeler 104 and a business requirements management tool 106. Conceptual modeler 104 develops a conceptual model to facilitate generating an IT solution that is aligned to a business whose activities are supported by the IT solution. Conceptual modeler 104 is the conceptual modeler described in U.S. patent application Ser. No. 11/751,951. Conceptual modeler 104 outputs a conceptual model that is input into a requirements analyzer/designer 108 included in IT project plan and build management system 102. Business requirements defined or updated by business requirements management tool 106 are also input into requirements analyzer/designer 108. Business requirements management tool 106 is, for example, Rational® RequisitePro® offered by International Business Machines Corporation. IT project plan and build management system 102 also includes a task analyzer/project planner 110. The functionality of requirements analyzer/designer 108 and task analyzer/project planner are described below relative to FIG. 3.

IT project plan and build management system 102 also includes a conceptual components viewer 111, a conceptual structure viewer 112, an operational concepts viewer 114, and an operational concepts documentation viewer 116. The functionality of viewers 111, 112, 114 and 116 are described below relative to FIG. 3.

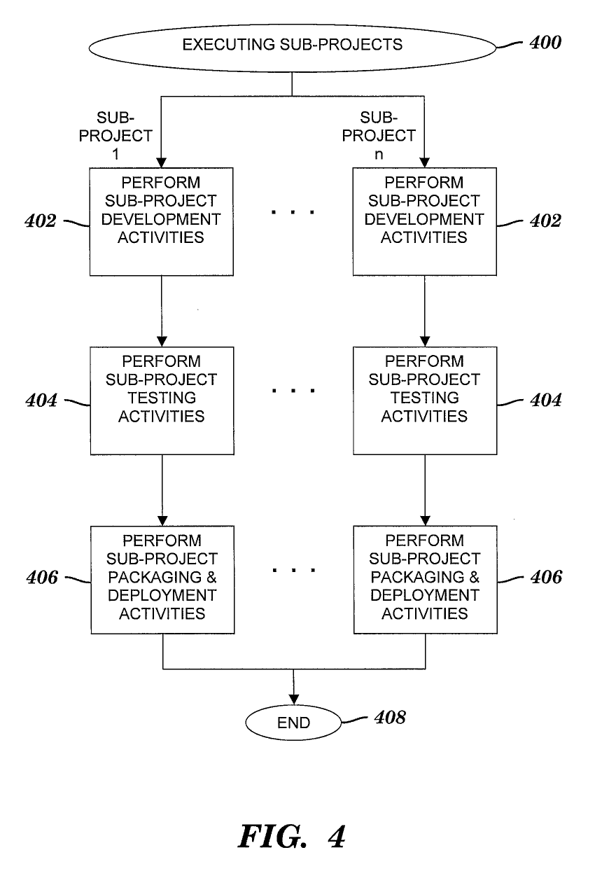

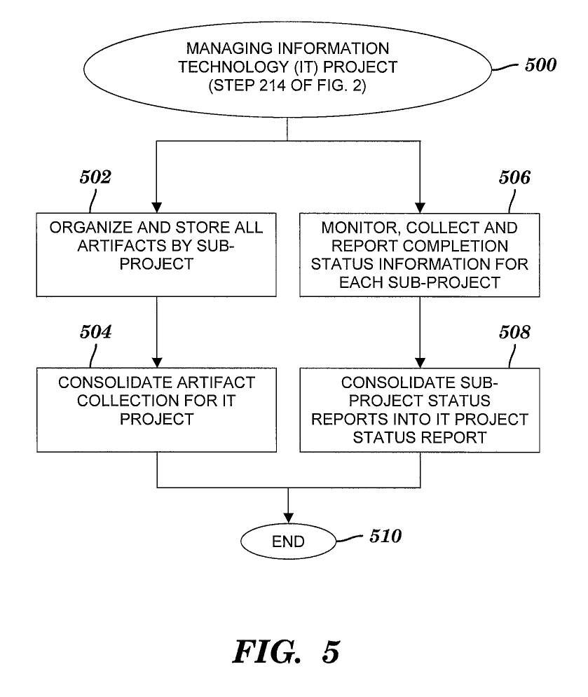

IT project plan and build management system 102 also includes a project status manager 118, a test plan manager 120, a packaging & deployment manager 122 and a visualizer 124, which are described below relative to FIGS. 4 and 5.

IT project plan and build management system 102 also includes an information manager 126, a project & sub-project activity and task repository 128, a conceptual components repository 130, a test plan repository 132, a conceptual structure repository 134, a status repository 136, an operational concepts repository 138, an operational concepts documentation repository 139 and a packaging & deployment plan repository 140.

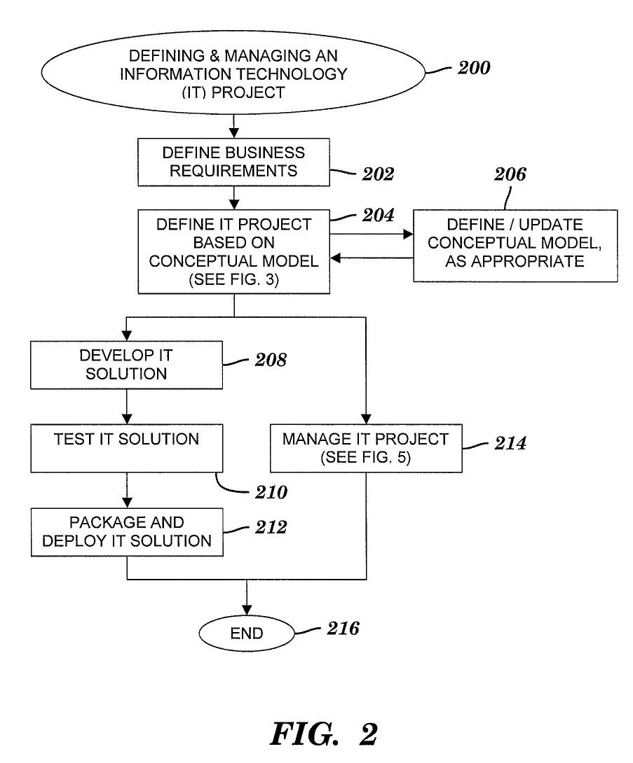

Project & sub-project activity and task repository 128 includes descriptions of activities, tasks and sub-tasks associated with projects and sub-projects. An activity is at a higher level of granularity compared to tasks and sub-tasks. An activity is, for example, designing, implementing, testing, packaging, or deploying as described below relative to FIGS. 2, 3 and 4. As used herein, an activity comprises various tasks related to the activity. A task is, for instance, developing high-level architecture, developing a service model using Service-Oriented Modeling and Architecture (SOMA) methodology offered by International Business Machines Corporation, developing a use case model, or developing a test plan. As used herein, a task comprises various sub-tasks related to the task. A sub-task is, for example, identifying a candidate service, applying the service litmus test, specifying services or realizing services. Activities, tasks and sub-tasks are actionable items that are planned in a project plan. Project management involves estimating time and effort requirements, cost, dependencies, schedules, system and tools requirements, etc. and managing the completion of these actionable items per estimates in the project plan.

Conceptual components repository 130, conceptual structure repository 134, operational concepts repository 138 and operational concepts documentation repository 139 are described below relative to FIG. 3.

Information manager 126 is used as an interface for project status manager 118 storing IT project status information in repository 136; test plan manager 120 storing test plans in repository 132; and packaging & deployment manager 122 storing packaging and deployment plans in repository 140.

In one embodiment, system 100 is modified so that information manager 126 and repositories 128, 130, 132, 134, 136, 138, 139 and 140 are external to IT project plan and build management system 102.

IT project plan and build management system 102 also includes a project plan and status report generator 142, a project plan importer/exporter 144, a test plan importer/exporter 146, and a packaging & deployment plan importer/exporter 148.

Project plan and status report generator 142 is used to generate project status report documentation. Project status reports can vary depending upon the specific project management method use by the client organization, as well as on other factors such as documentation standards, client organization, technologies and products used in the solution, financial and accounting methods used in the client organization, etc. Report generator 142 allows the customization of project status reports by custom configuring various client-dependent variables and mapping them to the project plan structure that is based on the conceptual model as described above. Reports generated by report generator 142 facilitate smoother adoption of the method of building IT solutions described in the present invention by enabling the status reports for an IT project to be produced and formatted according to pre-existing documentation standards in a client organization.

Report generator 142 primarily accesses project & sub-project activity and task repository 128 and status repository 136, although other repositories may also be accessed, including conceptual components repository 130. The status report customization information may be stored in a status report customization repository (not shown).

Project plan importer/exporter 144 enables system 102 to interface with standard project planning and project management tools such as Rational® Method Composer offered by International Business Machines Corporation and Microsoft® Project. By interfacing with these tools, system 102 can import pre-existing project plans and activities and their templates so that the project planning activities described herein can be applied to the imported project plans and activities. After a project plan is created or modified using system 102 as described herein, project plan importer/exporter 144 enables the project plan to be exported to the standard project planning and project management tools. The export function of importer/exporter 144 is supported regardless of whether a plan was imported from one of the standard tools. This support of the export function facilitates client organizations to leverage current investments in these standard tools and enable smoother adoption of system 102.

Test plan importer/exporter 146 enables system 102 to interface with industry standard test planning and test management tools such as Rational® TestManager offered by International Business Machines Corporation, Mercury TestDirector offered by Hewlett-Packard Company of Palo Alto, Calif., and SilkCentral® Test Manager offered by Borland® Software Corporation of Cupertino, Calif. By interfacing with these standard test planning and test management tools, system 102 can import pre-existing test plans and activities and their templates so that the test planning activities described herein can be applied to the imported test plans and activities. After a test plan is created or modified using system 102 as described herein, test plan importer/exporter 146 enables the test plan to be exported to the standard test planning and test management tools. The export function of importer/exporter 146 is supported regardless of whether a plan was imported from one of the standard tools. This support of the export function facilitates client organizations to leverage current investments in these standard tools and enable smoother adoption of system 102.

Packaging & deployment plan importer/exporter 148 enables system 102 to interface with industry standard package planning and deployment tools such as Tivoli® Provisioning Manager offered by International Business Machines Corporation. By interfacing with these standard tools, system 102 can import pre-existing package and deployment plans and their templates so that the packaging and deployment planning activities described herein can be applied to the imported package and deployment plans. After a packaging and deployment plan is created or modified using system 102 as described herein, packaging & deployment plan importer/exporter 148 enables the plan to be exported to the standard tools. The export function of importer/exporter 148 is supported regardless of whether a plan was imported from one of the standard tools. This export function facilitates client organizations to leverage current investments in these standard tools and enable smoother adoption of system 102.

Furthermore, IT project plan and build management system 102 includes project plan and status documentation 150, project planning and project management tools 152, test planning and test plan execution tools 154 and packaging & deployment planning and implementation tools 156.

Project plan and status documentation 150 is the output produced by project plan and status report generator 142. Documentation 150 includes standard documentation such as printed hardcopies and digital copies (e.g., PDF documents).

Project planning and project management tools 152 is a collection of current industry standard project planning and project management tools such as Rational® Method Composer and Microsoft® Project, which interface with system 102 via project plan importer/exporter 144.

Test planning and test plan execution tools 154 is a collection of current industry test planning and test plan management tools such as Rational® TestManager, Mercury TestDirector, and SilkCentral® Test Manager, which interface with system 102 via test plan importer/exporter 146.

Packaging & deployment planning and implementation tools 156 is a collection of current industry packaging and deployment planning and implementation tools such as Tivoli® Provisioning Manager, which interface with system 102 via packaging & deployment plan importer/exporter 148. In one embodiment, the functionalities of one or more of the components of system 100 which are described herein are automated and/or integrated in a software application.

### 4. PROCESS FOR DEFINING AND MANAGING IT PROJECTS

FIG. 2 is a flow diagram of an information technology project definition and management process implemented by the system of FIG. 1, in accordance with embodiments of the present invention. The IT project definition and management process starts at step 200. In step 202, business requirements for an IT solution are defined in business requirement management tool 106 (see FIG. 1) and input into the IT project plan and build management system 102 (see FIG. 1). Business requirements defined in step 202 are specified by business stakeholders in terms of business capabilities. Step 202 facilitates identifying the scope of changes (a.k.a. IT changes) needed in an existing IT solution or the scope of a new IT solution that needs to be built. IT changes needed may include changes to a conceptual model and changes to the design or to the internal processes and algorithms of the conceptual components. If changes are needed to the conceptual model, such changes are proposed and approved first through an appropriate governance process defined for the maintenance of the conceptual model.

A variety of methods for performing step 202 are used currently in the industry, including generating functional specifications, non-functional requirement specifications, use case flows, business operational modeling, business strategy and planning, etc. U.S. patent application Ser. No. 11/751,951 describes the variety of ways business requirements can be specified for an IT solution. In the present invention, the organization specifying the business requirements adopts the conceptual modeling method disclosed in U.S. patent application Ser. No. 11/751,951 in addition to the above-mentioned currently used methods. Thus, the business requirements defined in step 202 specifically call out changes to a conceptual model.

In step 204, business requirements defined in step 202 are analyzed and using the conceptual model as a reference, an IT project is defined. Defining the IT project in step 204 includes identifying the work activities needed, resources required, etc. Further, the IT project is defined in terms of a collection of sub-projects. The sub-projects are mapped to a conceptual model and the conceptual model's conceptual components and subcomponents. As used herein, a subcomponent is a constituent part of a conceptual component. The process of defining the IT project in step 204 is described in detail below relative to FIG. 3.

Since the structure and organization of the IT project defined in step 204 aligns with the conceptual structure, business and IT stakeholders obtain a better understanding of the extent of impact to a system within the IT solution. In a case where multiple projects are planned concurrently, the definition in step 204 facilitates the business and IT stakeholders in identifying and coordinating overlaps and dependencies among the multiple projects. Since conceptual components are already business-aligned, organizing IT solution building activities by the conceptual components assists stakeholders, especially business stakeholders, with visualizing the building activities and understanding how the parts of the system will come together. The IT project definition of step 204 also facilitates the analysis and planning for any bottlenecks or delays during the construction phase of the IT project by allowing stakeholders to more easily visualize the impact on the overall system, as well as the implications to specific business capabilities. The step 204 approach to defining and structuring IT projects also helps in assessing impact to a system during different stages of completion due to changes in the business context. For example, new partnerships or alliances are formed during the development of a complex system that change the functionality or the relevance of certain business capabilities and hence also change the functionality or relevance of certain conceptual components. If the IT project is already structured by the conceptual components, both IT and business stakeholders can more easily understand the impact of business requirements changes to their IT projects and respond appropriately.

The present invention enables the creation of software tools and technologies that facilitate the IT project definition of step 204 and assist the structuring of IT project activities in a consistent manner across different IT projects using a common reference model for both business and IT stakeholders. In one embodiment, output from any special software tools developed to define the conceptual model are fed directly into project management tools (e.g., Microsoft® Project) with appropriate integration enhancements, which then automatically create project definition and project plan sections that correspond to the conceptual structure. Such project management tools can be extended to analyze multiple project plans and automatically create visualizations of impacted areas of IT solution, as well as overlaps and dependencies among different projects and sub-projects, using the conceptual structure as the reference.

In step 206, a conceptual model is defined if one does not exist already for the IT solution. If a conceptual model already exists for the IT solution and the business requirements defined in step 202 require modifications to an existing IT solution, then step 206 includes updating the existing conceptual model according to the method disclosed in U.S. patent application Ser. No. 11/751,951. Step 206 is described below in more detail by the discussion relative to steps 304 and 308 of FIG. 3.

In step 208, the IT solution is developed. Developing the IT solution includes performing design and implementation activities (a.k.a. development activities or design and build activities). The present invention may include utilizing any of a variety of known design and implementation methodologies. A novel aspect of step 208 is performing the development activities specific to each sub-project defined in step 204 as a unit of work. In one embodiment, development activities specific to different sub-projects are performed in parallel. The sub-projects are aligned with conceptual components and subcomponents in the IT solution, and therefore provide a modularized approach to designing and implementing the IT solution. The parallel execution of the development activities for different sub-projects is shown in the parallel executions of step 402 of FIG. 4.

Step 208 includes monitoring and tracking the progress of IT project tasks and the work activities that were identified, broken down into work units, and assigned resources in step 204. Outputs and deliverables from the work activities are, for example, design specifications and unit tested code components. Collecting and organizing these outputs and deliverables is also a key activity in the IT sub-projects defined in step 204. The present invention uses the inherent structure of the conceptual model to organize, perform, and manage the aforementioned monitoring, tracking, collecting and organizing activities (a.k.a. IT activities). The method of the present invention includes maintaining compliance with the conceptual model throughout the course of the design and build activities. That is, design activities always hold true to the operational concepts and the structures and interfaces of the conceptual components of the conceptual model, while design and implementation details may change from one sub-project to another depending on various factors, including the use of specific technologies to achieve certain design objectives. If changes are needed to any aspect of the conceptual model, appropriate governance processes are utilized to make such changes. In the present invention, none of the work activities of any IT projects related to an IT solution can modify, on their own, the conceptual model, including any of its operational concepts. Thus, the conceptual model serves as a stable view of the business capabilities and the IT solution among business and IT stakeholders.

Planning, organizing and executing IT activities leveraging the inherent structure of the conceptual model enables the creation of software tools and technologies that improve the productivity and efficiency of IT projects significantly, and therefore improving the return on the IT investments for business. Document management tools can be configured to automatically organize project documentation to facilitate locating relevant requirements and design documents related to specific business capabilities. Business requirements management tools such as Rational® RequisitePro® offered by International Business Machines Corporation can be enhanced or configured appropriately to automatically map business requirements to code components based on the conceptual components in the conceptual model. Such an organization of code components directly benefits the testing activities based on the conceptual model, which are described below relative to step 210. Furthermore, project management tools can be developed that help project managers visualize the progress made by automatically tracking activities related to specific business capability areas. The present invention facilitates drilling down by project managers in specific business capability areas to determine the health and progress of their project activities

In step 210, an IT solution is tested at different levels. The testing in step 210 includes unit testing, conceptual component testing, integration testing, system testing, user acceptance testing, etc. Unit testing is a procedure used to validate that individual units of source code are working properly. A unit is the smallest testable part of an application. In step 210, conceptual component testing is performed after unit testing. Conceptual component testing is performed at the conceptual component level or subcomponent level, which is enabled by the present invention's break up of IT development activities into sub-projects that are aligned with conceptual components or subcomponents as described above relative to step 208. The operational concepts described in U.S. patent application Ser. No. 11/751,951 describe how a conceptual component or subcomponent must operate. Conceptual component testing includes validating that a conceptual component or subcomponent operates in accordance with the operational concepts. Test cases can be defined at the component level and subcomponent level (i.e., at modular levels) and can be executed to test the proper operation of the IT solution at these modular levels.

Further, integration testing, system testing and user acceptance testing are performed in step 210 with conceptual components and subcomponents as the building blocks, rather than code components aggregated into different technical components defined by IT stakeholders. Thus, integration testing in step 210 includes testing the integration of two or more conceptual components of an IT solution and the conceptual components' interfaces within the scope of one or more sub-projects. System testing in step 210 includes testing a complete IT solution including the IT solution's integration with other applications. User acceptance testing in step 210 is performed by business stakeholders and includes testing an IT solution against business requirements.

The parallel execution of the testing activities for different sub-projects is illustrated by the parallel execution of step 404 of FIG. 4. Testing activities in different sub-projects may be coordinated as needed and appropriate to the progress made in different sub-projects. For example, while tests at the conceptual component level can be executed independent of each other, integration testing, by definition, requires two or more conceptual components or subcomponents to be tested together. Similarly, when integration testing has been completed, thus validating the integration of the results of various sub-projects, system testing can be executed. System testing requires aligning the testing activities across all sub-projects that are within the scope of the completed IT solution to be delivered. The present invention allows for the scope of the completed IT solution to be modified during the execution of the IT project for a variety of business and technical reasons, such as mergers and acquisitions, new partnerships, budget changes, resource availability, socio-political influencers, technology changes, project delays, technical design failures, etc. Since the IT project is broken down into sub-projects, each of which is aligned with conceptual components or subcomponents, the IT project may be re-scoped during the execution phase (i.e., steps 208, 210 and 212) by adding sub-projects to or removing sub-projects from the scope of the IT project to be completed by a certain time.

Similar to how system testing is aligned, user acceptance testing may also be aligned across different sub-projects as appropriate to the IT solution, depending upon the scope of the IT project to be completed by a certain time.

Testing is performed in step 210 in such a way that business capabilities form the backdrop for all testing activities, starting with unit testing. Since development activities are organized using the inherent structure of the conceptual model, the business capability related to a completed code component is obvious. The present invention facilitates monitoring, by project managers and other IT stakeholders, the completion of unit tests that relate to specific business capabilities. This monitoring enables the IT stakeholders to plan testing at the conceptual component level once the critical code components for a conceptual component are tested and ready. While unit testing of code components serves as an indicator of the stability of the conceptual components even before all the code components are ready at the conceptual component level, testing at the conceptual component level serves as an indicator of stability at the system level even before all the conceptual components are tested and ready for integration testing. Furthermore, since the conceptual components correspond to business capabilities, this approach to testing provides much improved visibility to the development of business capabilities continually through the development process and facilitates better collaboration among business and IT stakeholders.

The present invention enables automated test suites to be developed at various levels of the system. At the code component level, automated test suites can verify the proper operation of individual code components. At the conceptual component level, automated test suites can verify the proper operation at the business capability level in a manner compliant with the conceptual model. At an integration test level, automated test suites can verify the proper operation of the integration of specific business capabilities in a manner compliant with the conceptual model. At the system level, automated test suites can verify the proper operation of the system as a whole in a manner compliant with the conceptual model. The test suites that validate compliance with the conceptual model are independent of specific implementation versions of the conceptual components. Thus, the invention leads to a stable view of the system among business and IT stakeholders even though there may be ongoing changes in technology, functions and features of the IT solution. Since the conceptual model itself evolves over time, the present invention provides for a partitioning of the test suites into a series of consecutive tests that account for the incremental changes to the conceptual components as the conceptual model evolves.

In step 212, the IT solution is packaged and deployed. Step 212 includes packaging various software-related artifacts related to the IT solution into modules or file archives, distributing the artifacts to the appropriate locations and appropriate hardware and software platforms, and installing the artifacts as needed to enable the operation of the IT solution. The artifacts include code, as well as various others such as architecture specifications, process models, Unified Modeling Language (UML) models, user guides, installation guides, release notes, service-oriented architecture (SOA) service models, SOA service specifications, etc. that are related to the IT solution being delivered. In the present invention, the artifacts are packaged based on the conceptual components. Since the sub-projects are aligned with the conceptual components, artifacts that are produced and consumed within sub-projects are related to specific conceptual components. Therefore, artifacts related to a sub-project, when packaged together, result in modular packaging of the IT solution based on the conceptual components.

Modular packaging of the IT solution, based on conceptual components, enables the modular construction of the IT solution during deployment time. Component-level, integration, and system test cases developed and used in step 210 can be used at deployment time as well to validate the proper functioning of conceptual components, the conceptual components' integration, as well as the functioning of the IT system as a whole. Additional build-time test cases can be defined, depending on the needs of the specific deployment architecture, based on the conceptual structure of the IT solution. The aforementioned tests relative to step 212 can also help validate the stability of the IT solution at various stages of deployment and the proper operation of the IT solution as a whole when the deployment has been completed.

Depending on the granularity of structures defined within conceptual components, code components can be identified easily for internal structures within conceptual components and packaged appropriately as deployment units. The present invention allows IT solutions to be built up from different constituent conceptual components, in a series of assembly steps. Furthermore, the stability of integration of the system being constructed can be verified and validated using the same automated test suites that were used during the testing phase (see step 210). The present invention's approach of progressively assembling business capabilities while building a system contrasts with current methods that install and bring together all code components first, before any testing for business capabilities can begin. The present invention's system building approach utilizes the conceptual model to create business-aligned building blocks for IT solutions.

The present invention enables deployment tools to be built that allow visual construction of IT solutions, one business capability at a time, continually validating the stability of the solution being built. The present invention allows a business capability to be replaced by an equivalent business capability built internally within the enterprise or by third-party vendors. In one embodiment, software tools are built to automatically identify all the impacted business capabilities when functionality of a code or technology component fails. In one embodiment, system building tools are created that provide a visual interface to build custom configured systems with selected business capabilities and automatically validate and verify the completeness and proper operation of the resulting system.

In step 214, the IT project is managed. Step 214 includes the collecting, organizing, and storing of the various aforementioned artifacts related to the IT project and its sub-projects, as well as tracking, monitoring, reporting, and managing various activities in an IT project and its sub-projects throughout the lifecycle of an IT project. Details of step 214 are provided below by the discussion of FIG. 5. The process of defining and managing an IT project ends at step 216.

In a first embodiment, multiple IT projects are planned and executed sequentially using the process of FIG. 2 for each of the IT projects. In a second embodiment, multiple IT projects are commonly planned and executed concurrently and independently by different business units in an enterprise. For example, the sales department of a corporation creates an IT project to enhance the IT solution for billing, while the human resources department of the corporation creates an IT project to update the IT solution for payroll. The IT projects of this example are defined and executed independently and concurrently using the process of FIG. 2. Each IT project is broken down into sub-projects and managed as described herein relative to FIGS. 2-5.

FIG. 3 is a flow diagram of a conceptual model-based information technology project definition process included as step 204 of FIG. 2, in accordance with embodiments of the present invention. The conceptual model-based IT project definition process starts at step 300. In step 302, the impacted conceptual components of the conceptual model are identified. In step 302, requirements analyzer/designer 108 (see FIG. 1) analyzes requirements for the IT solution to identify which of the conceptual components in the conceptual model for the IT solution are impacted (i.e., require some kind of update or modification).

The analysis in step 302 may determine that an update to the conceptual structure for the IT solution is required. In step 304, any required update to the conceptual structure is performed by the method described in U.S. patent application Ser. No. 11/751,951. For IT solutions being newly developed, step 304 develops the conceptual structure using the method described in U.S. patent application Ser. No. 11/751,951.

In step 306, the requirements analyzer/designer 108 (see FIG. 1) examines the specified requirements for the IT solution and identifies specific IT development activities needed, corresponding to each of the impacted conceptual components identified in step 302, to create a new IT solution or update an existing IT solution in order to meet the specified requirements. For new IT solutions, the operational concepts must be defined first using the method described in U.S. patent application Ser. No. 11/751,951. For an existing IT solution that will be modified to meet the specified requirements, any needed changes to the operational concepts for the IT solution must be made using the method described in U.S. patent application Ser. No. 11/751,951 prior to the completion of step 306.

The specific IT development activities identified in step 306 are described using the conceptual model as the basis. As defined in U.S. patent application Ser. No. 11/751,951, a conceptual model comprises a conceptual structure and operational concepts. The IT development activities identified and their descriptions depend on specific IT development methodologies used, as well as various other factors such as technologies used, applications involved, completion timelines warranted by business, cost, budget, resource availability, etc. The IT development activities identified and their descriptions are presented as a high-level overview in step 306. Steps 310, 312 and 314 transform this high-level overview into sub-projects that correspond to conceptual components and define tasks and sub-tasks for the sub-projects.

Step 306 uses the conceptual model as a basis for the identified IT development activities by accessing, via information manager 126 (see FIG. 1), information in conceptual structure repository 134 (see FIG. 1); operational concepts repository 138 (see FIG. 1), conceptual components repository 130 (see FIG. 1) and operational concepts documentation repository 139 (see FIG. 1).

Conceptual structure repository 134 (see FIG. 1) defines (1) the structure of the IT solution in terms of the various conceptual components and subcomponents that comprise the IT solution and (2) the relationships among these conceptual components and subcomponents.

Operational concepts repository 138 (see FIG. 1) defines various concepts behind how the IT solution operates and delivers required functionality utilizing (1) the various conceptual components and subcomponents that comprise the IT solution and (2) the conceptual components' and subcomponents' respective functionality and interactions.

Conceptual components repository 130 (see FIG. 1) describes in detail the structure and operational concepts for the various conceptual components and subcomponents. Thus, conceptual components repository 130 (see FIG. 1) facilitates gaining a modular view of the IT solution. Conceptual components repository 130 (see FIG. 1) does not add new information that is not already contained in conceptual structure repository 134 (see FIG. 1) and operational concepts repository 138 (see FIG. 1). Rather, the conceptual components repository draws upon the information contained in the conceptual structure and operational concepts repositories and packages and serves this information specific to each conceptual component and subcomponent.

Operational concepts documentation repository 139 (see FIG. 1) stores operational concepts documentation generated by an operational concepts documentation generator described in U.S. patent application Ser. No. 11/751,951.

The accessed information from repositories 130, 134, 138 and 139 are viewed by a user via conceptual components viewer 111 (see FIG. 1), conceptual structure viewer 112 (see FIG. 1), operational concepts viewer 114 (see FIG. 1) and operational concepts documentation viewer 116 (see FIG. 1), respectively. The high-level overview description of the IT development activities that is generated in step 306 is stored in project and sub-project activity and task repository 128 (see FIG. 1).

In step 306, the requirements analyzer/designer 108 (see FIG. 1) examines the specified requirements for the IT solution and identifies any changes to the operational concepts of the IT solution that are needed to implement the IT solution so as to meet the specified requirements. If changes are needed to the operational concepts for an existing IT solution, then step 308 makes the changes using the method described U.S. patent application Ser. No. 11/751,951. For an IT solution being newly developed, step 308 defines the operational concepts using the method described in U.S. patent application Ser. No. 11/751,951.

Again, step 306 identified at a high-level the IT development/update activities required using the conceptual model as the basis. In step 310, development/update activities identified in step 306 are grouped into sub-projects that are aligned with the conceptual components. Task analyzer/project planner 110 (see FIG. 1) performs step 310. A sub-project is defined in step 310 for each conceptual component that requires a design or implementation change. In one embodiment, a sub-project is defined to make the necessary design or implementation changes to a subcomponent of a conceptual component. The primary purpose of defining sub-projects is to enable a modular construction of the IT solution. Sub-projects can be executed in parallel (e.g., by different teams that are geographically distributed). Sub-projects can also be outsourced to different vendors easily, if such outsourcing is appropriate.

Step 310 is repeated for each conceptual component impacted by the specified requirements of the IT solution, as identified in step 302. Step 310 also refines a sub-project definition iteratively as steps 310, 312 and 314 are completed for each conceptual component and for any subcomponents thereof.

Step 310 aligns sub-projects with conceptual components by accessing, via information manager 126 (see FIG. 1), information in conceptual structure repository 134 (see FIG. 1), operational concepts repository 138 (see FIG. 1), conceptual components repository 130 (see FIG. 1), and operational concepts documentation repository 139 (see FIG. 1). The information from repositories 130, 134, 138 and 139 accessed in step 310 are viewed by a user via conceptual components viewer 111 (see FIG. 1), conceptual structure viewer 112 (see FIG. 1), operational concepts viewer 114 (see FIG. 1) and operational concepts documentation viewer 116 (see FIG. 1). The sub-project defined in step 310 is described and stored in the project and sub-project activity and task repository 128 (see FIG. 1).

In step 312, task analyzer/project planner 110 (see FIG. 1) defines (i.e., identifies and describes) the specific development, testing, and deployment tasks and sub-tasks included in the sub-project defined in step 310. The tasks and subtasks defined in step 312 include all activities related to developing, testing, packaging, and deploying a conceptual component or a conceptual component's subcomponent as a part of an overall IT solution. Thus, the scope of each sub-project defined in step 310 is constrained to a conceptual component or subcomponent. The tasks and sub-tasks defined in step 312 are dependent on a variety of factors including technologies, architecture, tools, software applications involved, and other technical factors, as well as, business-related factors such as a decision to outsource, supplier, geographical location of teams and resources, budget, delivery timelines, etc. Step 312 is performed, for example, by personnel skilled in project planning who have been trained in the principles of modular construction enabled by the present invention.

Step 312 is repeated for each conceptual component impacted by the specified requirements of the IT solution. Step 312 also refines the definition of tasks and sub-tasks iteratively as steps 310, 312 and 314 are completed for each conceptual component and for any subcomponents thereof.

Step 312 includes a user utilizing viewers 111, 112, 114 and 116 of FIG. 1 to view the IT solution's conceptual components, conceptual structure, operational concepts and operational concepts documentation, respectively. The information viewed in step 312 is provided by accessing conceptual components repository 130 (see FIG. 1), conceptual structure repository 134 (see FIG. 1), operational concepts repository 138 (see FIG. 1) and operational concepts documentation repository 139 (see FIG. 1). The tasks and sub-tasks defined in step 312 are described and stored in the project and sub-project activity and task repository 128 (see FIG. 1).

While step 312 identified and described the tasks and sub-tasks for a sub-project, step 314 completes detailed descriptions (i.e., project plan details) for each of the tasks and sub-tasks. Task analyzer/project planner 110 (see FIG. 1) performs step 314. The project plan details of step 314 include a definition of the effort involved for each of the tasks and sub-tasks, resource allocations, cost, timelines, and dependencies for the tasks and sub-tasks.

The present invention provides a modularization of the IT project into a set of sub-projects that can be executed in parallel by, for example, different teams in different locations. The set of sub-projects includes sub-projects that are interdependent (i.e., includes sub-projects that are dependent on one another). Completing the project plan details for each sub-project in step 314 requires identifying and describing execution points within the interdependent sub-projects. These interdependent sub-projects must be aligned and synchronized during execution. Specifically, the testing and deployment activities for the interdependent sub-projects must be aligned and synchronized appropriately. The project plan details completed in step 314 are dependent on a variety of factors including technologies, architecture, tools, software applications involved, and other technical factors, as well as business-related factors such as a decision to outsource, supplier, geographical location of teams and resources, budget, delivery timelines, etc. Step 314 is performed, for example, by personnel skilled in project planning who have been trained in the principles of modular construction enabled by the present invention.

Step 314 is repeated for each conceptual component impacted by the specified requirements of the IT solution. Step 314 also refines the project plan details iteratively as steps 310, 312 and 314 are completed for each conceptual component and for any subcomponents thereof.

Step 314 includes a user utilizing viewers 111, 112, 114 and 116 of FIG. 1 to view the IT solution's conceptual components, conceptual structure, operational concepts and operational concepts documentation, respectively. The information viewed in step 314 is provided by accessing conceptual components repository 130 (see FIG. 1), conceptual structure repository 134 (see FIG. 1), operational concepts repository 138 (see FIG. 1) and operational concepts documentation repository 139 (see FIG. 1). The task and sub-task project plan details completed in step 312 are described and stored in the project and sub-project activity and task repository 128 (see FIG. 1).

In step 316, task analyzer/project planner 110 (see FIG. 1) consolidates a project definition. That is, task analyzer/project planner 110 (see FIG. 1) consolidates the different sub-projects defined in step 310 into an overall project plan that defines how the IT solution is to be constructed. The consolidated project definition is stored in the project and sub-project activity and task repository 128 (see FIG. 1). The consolidation of step 316 preserves the sub-project boundaries, and hence their modular characteristic, thereby enabling the parallel execution of the sub-projects. However, the sub-project plans can be aggregated and/or partitioned as needed to improve the clarity of the overall project activities. The aggregation and partitioning of sub-projects are dependent on a variety of factors including technologies, architecture, tools, software applications involved, and other technical factors, as well as, business-related factors such as a decision to outsource, supplier, geographical location of teams and resources, budget, delivery timelines, etc. Step 316 is performed, for example, by personnel skilled in project planning who have been trained in the principles of modular construction enabled by the present invention. The process of defining an IT project based on a conceptual model ends at step 318.

FIG. 4 is a flow diagram of a parallel execution of multiple sub-projects included in the process of FIG. 2, in accordance with embodiments of the present invention. The process of executing multiple sub-projects in parallel starts at step 400. Steps 402, 404, and 406 may be executed independently for each sub-project (i.e., independently for sub-projects 1, . . . , n in FIG. 4) except when there are dependencies among sub-projects as defined in step 314 (see FIG. 3). When there are dependencies among sub-projects, the sub-projects are managed in different ways depending upon their nature by personnel skilled in project planning who have been trained in the principles of modular construction enabled by the present invention. Generally, during design and implementation, if a dependency exists between sub-project X and sub-project Y, then each of the sub-projects X and Y are allowed to proceed in parallel by simulating the dependency and synchronizing the two sub-projects at pre-defined critical checkpoints, and validating the dependency for each project appropriately. For example, if sub-project X has a dependency on a function being implemented in sub-project Y, support interfaces for the function under development in sub-project Y can be simulated in sub-project X to allow the design and implementation tasks and sub-tasks in sub-project X to proceed to completion even before sub-project Y completes. Such simulation techniques are also used during the testing activities performed in step 404 described below. For example, simulation techniques are used during unit testing to allow the interdependent sub-projects to be executed in parallel up until the completion of their respective unit testing stages. Integration testing must be done using the unit tested implementations of the conceptual components whose integration is being tested. System testing is performed only when the sub-projects for all the impacted conceptual components have completed their respective unit testing and integration testing stages. User-acceptance testing is performed only when system testing has been completed. Such dependencies, their validation checkpoints and simulation needs are identified and detailed in step 314 of FIG. 3.

In steps 402, 404 and 406, project status manager 118 (see FIG. 1) tracks progress made on tasks and sub-tasks of each sub-project. The progress information tracked by project status manager 118 (see FIG. 1) is stored in status repository 136 (see FIG. 1) in steps 402, 404, and 406. In steps 402, 404, and 406, visualizer 124 (see FIG. 1) uses the conceptual model together with the aforementioned progress information to visualize the progress made on tasks and sub-tasks within the context of the conceptual model at any time during the lifecycle of an IT project.

In step 402, the design and implementation activities defined for a sub-project are performed. Visualizer 124 (see FIG. 1) is used in step 402 to graphically visualize the progress being made in the development of a conceptual component.

In step 404, various types of tests are executed to verify the proper operation of a conceptual component (e.g., unit testing, conceptual component testing, integration testing, system testing, and user acceptance testing). Conceptual component testing in step 404 verifies the proper operation of a conceptual component prior to its integration with other conceptual components. Conceptual component tests require the interactions of a conceptual component with other conceptual components to be tested by simulating the presence of other conceptual components. By using the method disclosed herein, the operation of a conceptual component can be verified much earlier in the overall project lifecycle. Since the conceptual components are business-aligned, verification of the proper operation of a conceptual component early in the IT project lifecycle provides valuable feedback to business stakeholders regarding the viability of the IT solution and the stability of the IT solution under construction.

Integration testing in step 404 is performed at the sub-project level and involves testing how well a conceptual component integrates with other conceptual components in the IT solution. Integration testing is done by synchronizing the testing activities for two or more conceptual components, as described in the project definition developed in the process of FIG. 3.

System testing in step 404 involves all the impacted conceptual components as described in the project definition developed in the process of FIG. 3.

User Acceptance testing in step 404 is performed using the complete IT solution as described in the project definition developed in the process of FIG. 3.

Test plan manager 120 (see FIG. 1) is used in step 404 to generate and execute test plans. Executing a test plan executes one or more of the aforementioned tests. The test plans and test execution information are stored in test plan repository 132 (see FIG. 1) in step 404. Visualizer 124 (see FIG. 1) is used in step 404 to graphically visualize the progress being made in the testing of a conceptual component. In step 404, visualizer 124 (see FIG. 1) uses the conceptual model together with the test plan and test execution information to visualize test progress.

In step 406, various software-related artifacts related to a sub-project are: (1) packaged into modules or file archives, (2) distributed to appropriate locations and appropriate hardware platforms, and (3) installed as needed to enable the operation of a conceptual component within the IT solution. Packages from a sub-project may be aggregated with other packages from other sub-projects at different levels of granularity depending upon various factors such as technologies involved, installation tools, distribution media and methods, deployment architecture, deployment locations, etc. Regardless of the variations in the aggregation of the packages, the identity of packages generated in a sub-project is retained at all times, thus enabling the installation and un-installation of the artifacts related to a specific conceptual component in the IT solution.

As described above in step 212 of FIG. 2, the artifacts can include code, as well as various others such as architecture specifications, process models, UML models, user guides, installation guides, release notes, SOA service models, SOA service specifications, etc. that are related to the conceptual component delivered. Thus, the packaging that results from a sub-project is essentially a modular building block of the complete IT solution. Such packaging of the artifacts from a sub-project enables the modular construction of the IT solution during deployment time. In one embodiment, conceptual component-level test cases developed above in step 210 (see FIG. 2) are used at deployment time as well to validate the proper functioning of a conceptual component and its integration within the IT solution. Additional build-time test cases may be defined, depending on the needs of the specific deployment architecture of the IT solution, based on the conceptual model of the IT solution. These tests additionally help validate the stability of the conceptual component at various stages of deployment, as well as, proper operation of the IT solution as a whole when the deployment has been completed.

Packaging & deployment manager 122 (see FIG. 1) is used in step 406 to design various packages and plan deployment activities. In step 406, packaging & deployment manager 122 (see FIG. 1) stores the packaging details and the deployment steps and instructions in packaging & deployment plan repository 140 (see FIG. 1). Visualizer 124 (see FIG. 1) is used in step 406 to graphically visualize the packages corresponding to a conceptual component within the context of the overall packaging of the IT solution. In step 406, visualizer 124 (see FIG. 1) uses the conceptual model together with the packaging and deployment information to visualize packaging details for any conceptual component within an IT solution. The process of FIG. 4 ends at step 408.

It must be noted that the deployment of an IT solution may be repeated multiple times at the same or different locations. These repeat deployments may occur for a variety of reasons after the completion of the process of FIG. 4, such as deploying the IT solution for different clients. These repeat deployments may be done using similar deployment tasks and sub-tasks as performed within the different sub-projects. In one embodiment, the packaging & deployment manager 122 (see FIG. 1), along with the packaging details and the deployment steps and instructions in packaging & deployment plan repository 140 (see FIG. 1) and the Visualizer 124 (see FIG. 1) may be used to manage these repeat deployments even when the repeat deployments are outside the scope of the IT project. In another embodiment, such repeat deployments may be managed through the use of packaging & deployment planning and implementation tools 156 (see FIG. 1) outside of the system 102 (see FIG. 1), taking advantage of the packaging & deployment plan importer/exporter 148 (see FIG. 1) in the system 102 (see FIG. 1).

FIG. 5 is a flow diagram of an information technology project management process included in the process of FIG. 2, in accordance with embodiments of the present invention. The IT project management process begins at step 500. As described above relative to FIGS. 3 and 4, the IT project is broken down into sub-projects that are executed in parallel and synchronized as needed during different stages of the lifecycle of the project. Every IT project involves a set of artifacts ranging from code to others such as architecture specifications, process models, UML models, user guides, installation guides, release notes, SOA service models, SOA service specifications, etc. that are related to the IT solution delivered. The present invention breaks down an IT project into sub-projects based on the conceptual components.

Each sub-project involves a set of such artifacts that are specific to the conceptual component to which the sub-project is related. In step 502, packaging & deployment manager 122 (see FIG. 1) organizes and stores all artifacts related to each sub-project. Step 502 includes maintaining a comprehensive list of all sub-project related artifacts and tracking and storing these artifacts as they evolve during the lifecycle of the IT project. Packaging & deployment manager 122 (see FIG. 1) is used in step 502 to define the artifacts, organize the artifacts by sub-project, and collect appropriate meta-data about the artifacts. These artifacts are catalogued and stored on the basis of the conceptual components to which the artifacts are related. In step 502, packaging & deployment manager 122 (see FIG. 1) stores the artifacts and related meta-data information in packaging and deployment plan repository 140 (see FIG. 1).

The meta-data collected and stored by packaging & deployment manager 122 (see FIG. 1) is used to search for and locate any of the artifacts from within packaging & deployment plan repository 140 (see FIG. 1). In step 502, visualizer 124 (see FIG. 1) enables the viewing and visualization of the sub-project artifacts within the context of the overall conceptual model for the IT solution.

In step 504, packaging & deployment manager 122 (see FIG. 1) aggregates (i.e., consolidates) the sub-project artifacts organized and stored in step 502 into structures that facilitate IT project management activities, such as those described below in steps 506 and 508. In step 504, visualizer 124 (see FIG. 1) enables the viewing and visualization of the project artifacts using the defined IT project management structures.

In step 506, project status manager 118 (see FIG. 1) monitors, collects, and reports completion status information for each sub-project defined in step 310 (see FIG. 3) based on conceptual components enabled by this step. In step 506, project status manager 118 (see FIG. 1) also stores the status completion information for sub-projects in status repository 136 (see FIG. 1). Visualizer 124 (see FIG. 1) is used in step 506 to view and visualize the status of a conceptual component at any time during the lifecycle of an IT project within the context of the conceptual model for the IT solution.

In step 508, project status manager 118 (see FIG. 1) aggregates the sub-project level completion status information into an overall IT project status report in specific ways that meet the needs of IT project management activities. The specific aggregation and reporting methods can vary depending upon the project management methods used. Regardless of these variations, the present invention facilitates accessing and viewing the status of a specific conceptual component within the context of the overall IT project and within the context of the various conceptual components in the conceptual model. Visualizer 124 (see FIG. 1) is used in step 508 to view and visualize the IT project level status and includes the capability to drill down to the level of each conceptual component or subcomponent. The process of FIG. 5 ends at step 510.

### 5. EXAMPLES

This section uses the learning solution example of U.S. patent application Ser. No. 11/751,951 to illustrate the methods described herein to plan IT projects and to use modular design, build, test, and deploy techniques.

The development plan category of the learning solution example is stated in U.S. patent application Ser. No. 11/751,951 as follows:

Development Plan:
1. The client wants to develop the learning solution over three phases, incrementally adding additional functionality to the learning solution each time.
2. The client wants to defer the learning content search capability until Phase 2.
3. The client wants to defer the capability to access content from partner learning systems until Phase 3.

In this section, three IT projects are defined—one for each stage of the development plan described above. It is assumed that these three IT projects are planned and executed sequentially, to meet the phased implementation schedule as required by the client. The three IT projects are described as follows:

IT Project 1: Build the learning solution from scratch.

IT Project 2: Add a learning content search capability.

IT Project 3: Add a capability to access content from a partner learning system.

5.1 IT Project 1: Build the Learning Solution from Scratch

IT Project 1 includes various steps from FIGS. 3-5, as shown below in subsections 5.1.1 through 5.1.13.

### 5.1.1 Step 302 (see FIG. 3): Identify Impacted Components in the Conceptual Model

At this stage, initially, a conceptual structure has not been developed yet. As a conceptual structure starts developing in step 304 (see FIG. 3), step 302 (see FIG. 3) can begin to use the conceptual structure to identify impacted conceptual components and subcomponents. It should be noted that steps 302 and 304 of FIG. 3 can be an iterative process. That is, projects will rarely have the luxury of completing step 304 (see FIG. 3) fully before proceeding with step 302 (see FIG. 3). But in any case, the outcome of step 302 (see FIG. 3) must be based entirely on the conceptual structure developed in step 304 (see FIG. 3).

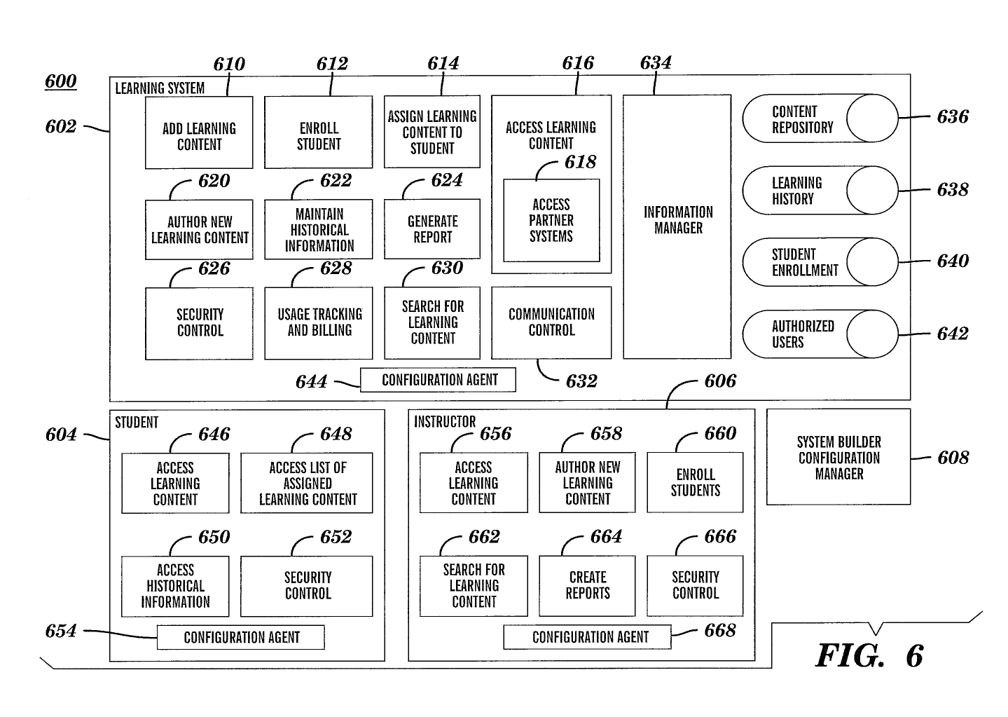

FIG. 6 depicts an exemplary conceptual structure 600 used for the learning solution example. Hereinafter, in this Examples section (i.e., Section 5), the learning solution whose conceptual structure is depicted in FIG. 6 is referred to simply as “the learning solution.” For IT project 1, the impacted conceptual components in conceptual structure 600 as identified in step 302 (see FIG. 3) are components 610, 612, 614, 616, 620, 622, 624, 626, 628, 632, 634, 636, 638, 640, 642 and 644 in learning system 602; components 646, 648, 650, 652 and 654 in student system 604; components 656, 658, 660, 664, 666 and 668 in instructor system 606; and system builder configuration manager 608. The components shown in FIG. 6 which are not listed above as being impacted relative to IT project 1 are impacted by stages 2 or 3 of the development plan and are included in the discussion below relative to IT projects 2 and 3.

Step 304 (see FIG. 3) is completed as described in U.S. patent application Ser. No. 11/751,951. Conceptual structure 600 is developed in step 304 (see FIG. 3) and is used in step 302 (see FIG. 3).

5.1.2 Step 306 (see FIG. 3): Describe IT development/update needed for conceptual components In this example, the learning solution does not exist at this stage; therefore step 306 (see FIG. 3) describes, at a high level, the plan to develop the overall learning solution and each of the impacted conceptual components identified in step 302 (see FIG. 3) above, using chosen technologies, tools, and related methodologies.

In this example, the learning solution is to be developed using the service-oriented architecture (SOA) approach. The SOMA methodology is used to define the services needed and the implementation activities needed. However, given the modular approach described in this invention, SOMA activities are applied within the context of each conceptual component separately, and not to the entire solution as a whole. Furthermore, whereas the SOMA methodology includes identification of the services needed, in the method of the present invention, services are identified primarily based on the functions defined in the concepts of operations developed in step 308 (see FIG. 3). Thus, the description includes:
A description of the learning solution as consisting of a learning system implemented on industry-standard platforms such as WebSphere® Application Server, WebSphere® Process Server, and WebSphere® Portal Server, which are offered by International Business Machines Corporation.
A description of how processes specific to each conceptual component are modeled separately using WebSphere® Business Modeler
A description of how each conceptual component is implemented by orchestrating services within the conceptual component as well as a within other conceptual components in the learning system.

At this stage, initially, the operational concepts for the learning solution have not been developed yet. As the operational concepts begin to develop in step 308 (see FIG. 3), step 306 (see FIG. 3) can begin to be use the operational concepts to describe the learning solution development. It should be noted that steps 306 and 308 of FIG. 3 can be an iterative process. Projects do not usually have the luxury of completing step 308 (see FIG. 3) fully before progressing with step 306 (see FIG. 3). But in any case, the outcome of step 306 (see FIG. 3) must be based on the operational concepts developed in step 308 (see FIG. 3) and be fully compatible with the operational concepts.

Step 308 (see FIG. 3) is completed as described in U.S. patent application Ser. No. 11/751,951. The operational concepts developed in step 308 are used in step 306 (see FIG. 3).

### 5.1.3 Step 310 (see FIG. 3): Define Sub-Project for Component

Step 310 (see FIG. 3) is repeated for each conceptual component of the learning solution that is in-scope as shown in FIG. 6. Again, in this example, the solution is being implemented using a SOA. In step 310, SOMA methodology is applied to identify and describe, at a high level, required activities related to each impacted conceptual component. The set of required activities for each conceptual component forms a sub-project.

Note that certain updates and modifications may be needed to the SOMA methodology in order to integrate SOMA with the method described herein.

5.1.4 Step 312 (see FIG. 3): Define Tasks and Sub-Tasks within the Sub-Project

The set of required activities identified in step 310 to implement an impacted conceptual component using SOMA methodology is further broken down in step 312 into detailed tasks and sub-tasks based on the impacted conceptual component.

It should be noted that certain updates and modifications may be needed to the SOMA methodology and its template of tasks and sub-tasks in order to integrate SOMA with the method described herein.

### 5.1.5 Step 314 (see FIG. 3): Complete Project Plan Details for Sub-Project

Step 314 includes defining the effort involved for each of the tasks and sub-tasks defined in step 312, as well as resource allocations, cost, timelines, and dependencies for the tasks and sub-tasks. The tasks and sub-tasks are derived and adapted from various SOMA-related templates, guidelines, and assets. The dependencies among the different conceptual components of the learning solution are taken into account to align and synchronize the various design, implementation, and testing activities. For example, testing activities in the sub-project for the assign learning content to student conceptual component 614 in learning system 602 depend on the proper functioning of the add learning content conceptual component 610 and hence the completion of the sub-project corresponding to component 610. Therefore, integration testing must be planned in the sub-project for the assign learning content to student conceptual component 614 in learning system 602 following the completion of the sub-project associated with the add learning content conceptual component 610.

### 5.1.6 Step 316 (see FIG. 3): Consolidate Project Definition

Step 316 includes consolidating the sub-projects that correspond to the various conceptual components in the learning solution into appropriate partitions and aggregations based on a variety of considerations as described above relative to the discussion of FIG. 3. For example, the access learning content conceptual components 616, 646 and 656 included in learning system 602, student system 604, and instructor system 606, respectively, are related in functionality. The sub-project activities corresponding to conceptual components 616, 646 and 656 are aggregated under a single consolidated project plan section called “Access Learning Content” (a.k.a. Access Learning Content project plan section) so that they may be assigned to a specific team, such as a development team located in Bangalore, India. However, the three sub-projects that correspond, in a one-to-one manner, to the access learning content conceptual components 616, 646 and 656 in learning system 602, student system 604 and instructor system 606 are still significant and distinct from one another. These three sub-projects corresponding to components 616, 646 and 656 are each assigned to a different sub-team within the Bangalore, India development team. Aggregating sub-projects in this manner enables the tracking, monitoring, and management of a variety of project management parameters, such as schedule, cost, resource loading, etc.

### 5.1.7 Step 402 (see FIG. 4): Perform Sub-Project Development Activities

Using the example presented above in Section 5.1.6, there are three sub-projects corresponding to the access learning content conceptual components 616, 646 and 656 in learning system 602, student system 604 and instructor system 606. Hereinafter, in Section 5, the three sub-projects that correspond to conceptual components 616, 646 and 656 are referred to simply as “the three sub-projects” or “these three sub-projects.” The design and implementation activities in each of these three sub-projects are executed in parallel by each of the sub-teams within the development team in Bangalore, India. Designs developed by each of these sub-teams are coordinated and validated. Implementation activities within each of these three projects are completed in parallel by the different sub-teams.

### 5.1.8 Step 404 (see FIG. 4): Perform Sub-Project Testing Activities

Continuing the same example as presented above in Sections 5.1.6 and 5.1.7, conceptual component testing within each of the three sub-projects is performed in parallel. However, these three sub-projects perform integration testing in a coordinated manner so that the access learning content functionality can be tested from the perspective of each of the systems (i.e., learning system 602, student system 604 and instructor system 606) for compliance with the operational concepts.

### 5.1.9 Step 406 (see FIG. 4): Perform Sub-Project Packaging and Deployment Activities

Continuing the same example as presented above in sections 5.1.6 through 5.1.8, packaging and deployment activities within each of the three sub-projects are performed in parallel. However, decisions regarding how the implementation artifacts corresponding to the access learning content conceptual component from each of the three sub-projects must be organized and packaged for deployment are coordinated such that the user-interface designs, architecture specification, process model, UML diagrams, user instructions on how to access learning content, etc. are all packaged in a manner that makes it easy to find these related artifacts. Packaging of the code artifacts from each of these three sub-projects is performed in such a way that the access learning content functionality can be installed and tested for proper integration of learning system 602, student system 604 and instructor system 606 from the perspective of the access learning content functionality, even as the rest of the learning solution is still under construction.

### 5.1.10 Step 502 (see FIG. 5): Organize and Store All Artifacts by Sub-Project

As an example, a common directory structure is defined for the Access Learning Content project plan section, as described above in section 5.1.6, with three sub-directories—one for learning system 602, a second one for student system 604 and a third one for instructor system 606—in a development file server, where the different artifacts corresponding to the Access Learning Content project plan section are stored by the three sub-teams for their sub-project. Visualizer 124 (see FIG. 1) enables navigating to these artifacts through a user-interface based on the conceptual model. For example, clicking on the access learning content conceptual component 646 in student system 604 displays an organized view of the artifacts related to conceptual component 646. 5.1.11 Step 504 (see FIG. 5): Consolidate Artifact Collection for IT Project

In this example, step 504 includes a consolidation activity that enables the viewing of the artifacts in multiple ways, such as (1) viewing all artifacts related to learning system 602, organized by conceptual components in the learning system; (2) viewing all artifacts related to the Access Learning Content project plan section organized by learning system 602, student system 604 and instructor system 606; (3) viewing UML diagrams corresponding to the learning solution, organized by the conceptual components for learning system 602, student system 604 and instructor system 606; (4) viewing staffing resources allocated to learning system 602, organized by conceptual components in the learning system; and (5) viewing test plans for student system 604 organized by conceptual components in the student system.

### 5.1.12 Step 506 (see FIG. 5): Monitor, Collect and Report Completion Status Information for Each Sub-Project

In this example, step 506 monitors, collects and reports project management data, such as resource utilization, percentage complete, tasks and sub-tasks completed, review status of architecture and design specifications, etc. related to the access learning content conceptual component for each of the three sub-projects corresponding to learning system 602, student system 604 and instructor system 606.

5.1.13 Step 508 (see FIG. 5): Consolidate Sub-Project Status Reports into IT Project Status Report

The consolidation activity of step 508 enables the aggregation of the project management data collected within sub-projects to be viewed in multiple ways, depending upon the project methodologies and client-specific project management requirements. For example, using the data collected for the access learning content conceptual component from the three sub-projects corresponding to learning system 602, student system 604 and instructor system 606, the status of completion of the Access Learning Content project plan section is viewed for the learning solution as a whole. The details of such a consolidated view are based on specific project management methods and tools used to collect the sub-project level data. Visualizer 124 (see FIG. 1) indicates the degree of completion of the conceptual components in the conceptual structure diagram visually by partially filling in a fill-in color in the different conceptual components depending upon their completion status.

### 5.2 IT Project 2: Add Learning Content Search Capability

IT Project 2 is an incremental update to the learning solution developed by IT Project 1. Conceptual components 608, 630, 634, 636 and 662 are identified in step 302 (see FIG. 3) as being impacted.

IT Project 2 is broken down into sub-projects and executed similar to the example presented above in Section 5.1. Notable exceptions are in steps 304 and 308 of FIG. 3.

Step 304 (see FIG. 3) includes updating the existing conceptual structure 600 for IT Project 2 rather than developing the conceptual structure from scratch. In this example, the search for learning content conceptual components 630 and 662 are already defined in the conceptual structure 600 during IT Project 1. If components 630 and 662 were not already defined, then these components would be added to the conceptual structure 600 during IT Project 2.

Similarly, step 308 (see FIG. 3) includes updating existing operational concepts as needed for IT Project 2 rather than defining the operational concepts from scratch.

5.3 IT Project 3: Add Capability to Access Content from Partner Learning System

IT Project 3 is an incremental update to the learning solution developed by IT Project 2. Conceptual components 608, 628 and 616 and subcomponent 618 are identified in step 302 as being impacted.

IT Project 3 is broken down into sub-projects and executed similar to the example presented above in Section 5.1. Notable exceptions are in steps 304 and 308 of FIG. 3.

Step 304 (see FIG. 3) includes updating the existing conceptual structure 600 for IT Project 3 rather than developing the conceptual structure from scratch. In this example, the search for learning content conceptual components 628, 616, and subcomponent 618 are already defined in the conceptual structure 600 during IT Project 1. If components 628, 616, and subcomponent 628 were not already defined, then these components would be added to the conceptual structure 600 during IT Project 3.

Similarly, step 308 (see FIG. 3) includes updating existing operational concepts as needed for IT Project 3 rather than defining the operational concepts from scratch.

### Computing System

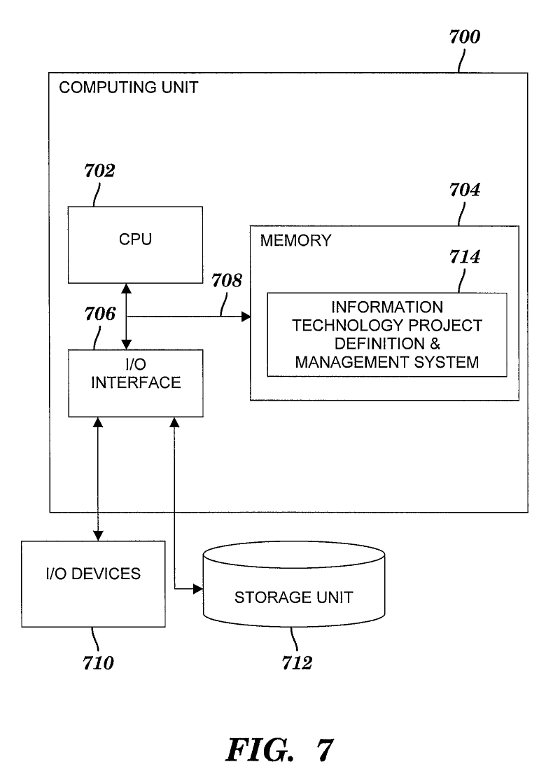

FIG. 7 is a block diagram of a computing system that implements the process of FIG. 2, in accordance with embodiments of the present invention. Computing unit 700 generally comprises a central processing unit (CPU) 702, a memory 704, an input/output (I/O) interface 706, a bus 708, I/O devices 710 and a storage unit 712. CPU 702 performs computation and control functions of computing unit 700. CPU 702 may comprise a single processing unit, or be distributed across one or more processing units in one or more locations (e.g., on a client and server).

Memory 704 may comprise any known type of data storage and/or transmission media, including bulk storage, magnetic media, optical media, random access memory (RAM), read-only memory (ROM), a data cache, a data object, etc. Cache memory elements of memory 704 provide temporary storage of at least some program code in order to reduce the number of times code must be retrieved from bulk storage during execution. Storage unit 712 is, for example, a magnetic disk drive or an optical disk drive that stores data. Moreover, similar to CPU 702, memory 704 may reside at a single physical location, comprising one or more types of data storage, or be distributed across a plurality of physical systems in various forms. Further, memory 704 can include data distributed across, for example, a LAN, WAN or storage area network (SAN) (not shown).

I/O interface 706 comprises any system for exchanging information to or from an external source. I/O devices 710 comprise any known type of external device, including a display monitor, keyboard, mouse, printer, speakers, handheld device, printer, facsimile, etc. Bus 708 provides a communication link between each of the components in computing unit 700, and may comprise any type of transmission link, including electrical, optical, wireless, etc.

I/O interface 706 also allows computing unit 700 to store and retrieve information (e.g., program instructions or data) from an auxiliary storage device (e.g., storage unit 712). The auxiliary storage device may be a non-volatile storage device (e.g., a CD-ROM drive which receives a CD-ROM disk). Computing unit 700 can store and retrieve information from other auxiliary storage devices (not shown), which can include a direct access storage device (DASD) (e.g., hard disk or floppy diskette), a magneto-optical disk drive, a tape drive, or a wireless communication device.

Memory 704 includes computer program code 714 for the IT technology project definition & management system and method disclosed herein. Further, memory 704 may include other systems not shown in FIG. 7, such as an operating system (e.g., Linux) that runs on CPU 702 and provides control of various components within and/or connected to computing unit 700.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code 714 for use by or in connection with a computing unit 700 or any instruction execution system to provide and facilitate the capabilities of the present invention. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, RAM 704, ROM, a rigid magnetic disk and an optical disk. Current examples of optical disks include compact disk-read-only memory (CD-ROM), compact disk-read/write (CD-R/W) and DVD.

Any of the components of the present invention can be deployed, managed, serviced, etc. by a service provider that offers to deploy or integrate computing infrastructure with respect to the method of defining and managing an IT project based on a conceptual model. Thus, the present invention discloses a process for supporting computer infrastructure, comprising integrating, hosting, maintaining and deploying computer-readable code into a computing system (e.g., computing unit 700), wherein the code in combination with the computing unit is capable of performing a method of defining and managing an IT project based on a conceptual model.

In another embodiment, the invention provides a business method that performs the process steps of the invention on a subscription, advertising and/or fee basis. That is, a service provider, such as a Solution Integrator, can offer to create, maintain, support, etc. a method of defining and managing an IT project based on a conceptual model. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

The flow diagrams depicted herein are provided by way of example. There may be variations to these diagrams or the steps (or operations) described herein without departing from the spirit of the invention. For instance, in certain cases, the steps may be performed in differing order, or steps may be added, deleted or modified. All of these variations are considered a part of the present invention as recited in the appended claims.

While embodiments of the present invention have been described herein for purposes of illustration, many modifications and changes will become apparent to those skilled in the art. Accordingly, the appended claims are intended to encompass all such modifications and changes as fall within the true spirit and scope of this invention. For example, the references to a business disclosed herein may be replaced with any organizational entity, regardless of whether the entity is a for-profit or a non-profit enterprise.

What is claimed is:

1. A method of defining and managing an information technology project based on a conceptual model, comprising:
defining, by one or more business stakeholders utilizing a computing system, a plurality of business requirements of an information technology (IT) solution, wherein said plurality of business requirements indicates a need for an update of a pre-defined conceptual model that represents a design of said IT solution, said pre-defined conceptual model including a plurality of conceptual components, said plurality of conceptual components representing one or more hardware components of said IT solution, one or more software components of said IT solution or a combination of said one or more hardware components and said one or more software components;
defining, via said computing system, a first IT project whose execution results in said IT solution, wherein said defining said first IT project comprises defining a plurality of sub-projects of said first IT project, wherein said defining said plurality of sub-projects comprises aligning said plurality of sub-projects with a subset of said plurality of conceptual components, a plurality of subcomponents of said subset, or any combination thereof, wherein said subset requires a plurality of modifications, each modification being a change in a design or an implementation of a conceptual component of said subset;
generating, via said computing system, said update of said pre-defined conceptual model;
performing, via said computing system, an execution phase of said first IT project; and
managing, via said computing system, said first IT project.

2. The method of claim 1, wherein said defining said first IT project further comprises:
describing, subsequent to said generating said update of said pre-defined conceptual model, one or more development activities for developing said IT solution, said describing said one or more development activities based on said pre-defined conceptual model; and
defining a plurality of tasks and a plurality of sub-tasks of said plurality of tasks, each task and each sub-task associated with a sub-project of said plurality of sub-projects, wherein an execution of a task of said plurality of tasks or a sub-task of said plurality of sub-tasks facilitates a development of said IT solution, a testing of said IT solution, a packaging of said IT solution or a deployment of said IT solution.

3. The method of claim 1, wherein said defining said first IT project further comprises describing a plurality of details for said plurality of tasks and said plurality of sub-tasks, wherein said describing said plurality of details comprises:
describing an effort for executing said plurality of tasks and said plurality of sub-tasks;
describing a resource allocation for executing said plurality of tasks and said plurality of sub-tasks;
describing a cost of executing said plurality of tasks and said plurality of sub-tasks;
describing a plurality of timelines for executing said plurality of tasks and said plurality of sub-tasks; and
describing one or more dependencies among said plurality of tasks and said plurality of sub-tasks.

4. The method of claim 1, wherein said defining said first IT project further comprises:
defining, for each conceptual component of said subset of said plurality of conceptual components and each subcomponent of said plurality of subcomponents, a plurality of tasks and a plurality of sub-tasks of said plurality of tasks, each task and each sub-task associated with a sub-project of said plurality of sub-projects, wherein an execution of a task of said plurality of tasks or a sub-task of said plurality of sub-tasks facilitates a development of said IT solution, a testing of said IT solution, a packaging of said IT solution or a deployment of said IT solution; and
describing, for each conceptual component of said subset and each subcomponent of said plurality of subcomponents, a plurality of details for said plurality of tasks and said plurality of sub-tasks.

5. The method of claim 4, wherein said defining said first IT project further comprises:
consolidating said plurality of sub-projects into an overall project plan that defines how said IT solution is to be generated or updated, wherein said consolidating preserves a modularity of said plurality of sub-projects,
wherein said method further comprises executing said plurality of sub-projects in parallel via a utilization of said modularity.

6. The method of claim 1, wherein said performing said execution phase comprises:
developing said IT solution, wherein said developing said IT solution comprises performing a plurality of design activities and a plurality of implementation activities for each sub-project of said plurality of sub-projects;
testing said IT solution, wherein said testing said IT solution comprises executing a plurality of testing activities for each sub-project of said plurality of sub-projects, thereby executing test cases at a plurality of modular levels, said modular levels including a plurality of conceptual component levels associated with said subset and a plurality of subcomponent levels associated with said plurality of subcomponents; and
packaging and deploying said IT solution for each sub-project of said plurality of sub-projects.

7. The method of claim 6, wherein said performing said plurality of design activities and said plurality of implementation activities is performed in parallel for a set of different sub-projects of said plurality of sub-projects.

8. The method of claim 6, wherein said executing said plurality of testing activities is performed in parallel for a set of different sub-projects of said plurality of sub-projects.

9. The method of claim 6, wherein said packaging and deploying comprises:
packaging a plurality of software-related artifacts associated with said IT solution into a packaged result, said packaged result being a plurality of modules or a plurality of file archives;
distributing said packaged result to hardware and software platforms according to pre-specified criteria; and
installing said packaged result to enable an operation of said IT solution.

10. The method of claim 9, wherein a software-related artifact of said plurality of software-related artifacts is selected from the group consisting of computer-readable code, a plurality of computer architecture specifications, a plurality of process models, a plurality of Unified Modeling Language (UML) models, a plurality of user guides, a plurality of installation guides, a plurality of release notes, a plurality of service-oriented architecture (SOA) service models and a plurality of SOA service specifications.

11. The method of claim 1, wherein said managing said first IT project comprises:
organizing and storing a plurality of artifacts by each sub-project of said plurality of sub-projects, said organizing and storing including aligning said plurality of artifacts with said subset of conceptual components, said plurality of subcomponents, or a combination thereof, wherein said plurality of artifacts is a result of said performing said execution phase.
consolidating said plurality of artifacts organized by each sub-project into a plurality of structures;
monitoring, collecting and reporting status information for each sub-project based on said subset of said plurality of conceptual components, wherein said monitoring, collecting and reporting are facilitated by said plurality of structures into which said plurality of artifacts are consolidated; and
consolidating said status information for said plurality of sub-projects into an overall status report of said first IT project,
wherein said organizing and storing said plurality of artifacts, said consolidating said plurality of artifacts, said monitoring, collecting and reporting said status information and said consolidating said status information facilitate multiple views of an aggregation of a plurality of activities associated with said plurality of sub-projects, and
wherein said multiple views of said aggregation preserve a result of said aligning said plurality of sub-projects with said subset of said plurality of conceptual components, said plurality of subcomponents, or any combination thereof.

12. The method of claim 1, further comprising:
defining, via said computing system, a second IT project, wherein said defining said second IT project comprises defining a second plurality of sub-projects of said second IT project, wherein said defining said second plurality of sub-projects comprises aligning said second plurality of sub-projects with a second subset of said plurality of conceptual components, a plurality of subcomponents of said second subset, or any combination thereof, wherein said second subset requires a second plurality of modifications, each modification of said second plurality of modifications being a change in a design or an implementation of a conceptual component of said second subset;
performing, via said computing system, an execution phase of said second IT project; and
managing, via said computing system, said second IT project,
wherein said defining said second IT project is performed independently of and concurrently with said defining said first IT project, and
wherein said performing said execution phase of said second IT project is performed independently of and concurrently with said performing said execution phase of said first IT project.

13. A computing system comprising a processor coupled to a computer-readable memory unit, said memory unit comprising a software application, said software application comprising instructions that when executed by said processor implement the method of claim 1.

14. A computer program product, comprising a computer usable medium having computer readable program code embodied therein for defining and managing an information technology project based on a conceptual model, said computer program product comprising:
computer-usable code for defining a plurality of business requirements of an information technology (IT) solution, wherein said plurality of business requirements indicates a need for an update of a pre-defined conceptual model that represents a design of said IT solution, said pre-defined conceptual model including a plurality of conceptual components, said plurality of conceptual components representing one or more hardware components of said IT solution, one or more software components of said IT solution or a combination of said one or more hardware components and said one or more software components;
computer-usable code for defining an IT project whose execution results in said IT solution, wherein said computer-usable code for defining said IT project comprises computer-usable code for defining a plurality of sub-projects of said IT project, wherein said computer-usable code for defining said plurality of sub-projects comprises computer-usable code for aligning said plurality of sub-projects with a subset of said plurality of conceptual components, a plurality of subcomponents of said subset, or any combination thereof, wherein said subset requires a plurality of modifications, each modification being a change in a design or an implementation of a conceptual component of said subset;
computer-usable code for generating said update of said pre-defined conceptual model;
computer-usable code for performing an execution phase of said IT project; and
computer-usable code for managing said IT project.

15. The program product of claim 14, wherein said computer-usable code for defining said IT project further comprises:
computer-usable code for describing, subsequent to said generating said update of said pre-defined conceptual model, one or more development activities for developing said IT solution, said describing said one or more development activities based on said pre-defined conceptual model; and
computer-usable code for defining a plurality of tasks and a plurality of sub-tasks of said plurality of tasks, each task and each sub-task associated with a sub-project of said plurality of sub-projects, wherein an execution of a task of said plurality of tasks or a sub-task of said plurality of sub-tasks facilitates a development of said IT solution, a testing of said IT solution, a packaging of said IT solution or a deployment of said IT solution.

16. The program product of claim 14, wherein said computer-usable code for defining said IT project further comprises computer-usable code for describing a plurality of details for said plurality of tasks and said plurality of sub-tasks, wherein said computer-usable code for describing said plurality of details comprises:
computer-usable code for describing an effort for executing said plurality of tasks and said plurality of sub-tasks;
computer-usable code for describing a resource allocation for executing said plurality of tasks and said plurality of sub-tasks;
computer-usable code for describing a cost of executing said plurality of tasks and said plurality of sub-tasks;
computer-usable code for describing a plurality of timelines for executing said plurality of tasks and said plurality of sub-tasks; and
computer-usable code for describing one or more dependencies among said plurality of tasks and said plurality of sub-tasks.

17. The program product of claim 14, wherein said computer-usable code for defining said IT project further comprises:
computer-usable code for defining, for each conceptual component of said subset of said plurality of conceptual components and each subcomponent of said plurality of subcomponents, a plurality of tasks and a plurality of sub-tasks of said plurality of tasks, each task and each sub-task associated with a sub-project of said plurality of sub-projects, wherein an execution of a task of said plurality of tasks or a sub-task of said plurality of sub-tasks facilitates a development of said IT solution, a testing of said IT solution, a packaging of said IT solution or a deployment of said IT solution; and
computer-usable code for describing, for each conceptual component of said subset and each subcomponent of said plurality of subcomponents, a plurality of details for said plurality of tasks and said plurality of sub-tasks.

18. A process for supporting computing infrastructure, said process comprising providing at least one support service for at least one of creating, integrating, hosting, maintaining, and deploying computer-readable code in a computing system, wherein the code in combination with the computing system is capable of performing a method of defining and managing an information technology project based on a conceptual model, said method comprising:
defining, by one or more business stakeholders utilizing a computing system, a plurality of business requirements of an information technology (IT) solution, wherein said plurality of business requirements indicates a need for an update of a pre-defined conceptual model that represents a design of said IT solution, said pre-defined conceptual model including a plurality of conceptual components, said plurality of conceptual components representing one or more hardware components of said IT solution, one or more software components of said IT solution or a combination of said one or more hardware components and said one or more software components;
defining, via said computing system, an IT project whose execution results in said IT solution, wherein said defining said IT project comprises defining a plurality of sub-projects of said IT project, wherein said defining said plurality of sub-projects comprises aligning said plurality of sub-projects with a subset of said plurality of conceptual components, a plurality of subcomponents of said subset, or any combination thereof, wherein said subset requires a plurality of modifications, each modification being a change in a design or an implementation of a conceptual component of said subset;
generating, via said computing system, said update of said pre-defined conceptual model;
performing, via said computing system, an execution phase of said IT project; and
managing, via said computing system, said IT project.

19. The process of claim 18, wherein said defining said IT project further comprises:
describing, subsequent to said generating said update of said pre-defined conceptual model, one or more development activities for developing said IT solution, said describing said one or more development activities based on said pre-defined conceptual model; and
defining a plurality of tasks and a plurality of sub-tasks of said plurality of tasks, each task and each sub-task associated with a sub-project of said plurality of sub-projects, wherein an execution of a task of said plurality of tasks or a sub-task of said plurality of sub-tasks facilitates a development of said IT solution, a testing of said IT solution, a packaging of said IT solution or a deployment of said IT solution.

20. The process of claim 18, wherein said defining said IT project further comprises describing a plurality of details for said plurality of tasks and said plurality of sub-tasks, wherein said describing said plurality of details comprises:
describing an effort for executing said plurality of tasks and said plurality of sub-tasks;
describing a resource allocation for executing said plurality of tasks and said plurality of sub-tasks;
describing a cost of executing said plurality of tasks and said plurality of sub-tasks;
describing a plurality of timelines for executing said plurality of tasks and said plurality of sub-tasks; and
describing one or more dependencies among said plurality of tasks and said plurality of sub-tasks.
